(19) United States
(12) Patent Application Publication
(10) Pub. No.: US 2009/0068385 A1
(43) Pub. Date: Mar. 12, 2009

(54) Device for labeling, tracking, and increasing the safety and security of industrial cylindrical containers within the chemical and petroleum industry

(75) Inventors: Michael David Hill, (US); Gary Clifford Hill, (US)

Correspondence Address: Michael Hill, 16462 Sundancer lane, Huntington Beach, CA, 92649, US

(73) Assignee: AoSA LLC, Huntington Beach, CA (US)

(21) Appl. No.: 11/852,955

(22) Filed: Sep. 10, 2007

(51) Int. Cl. B65B 53/02; B29C 53/36; B32B 1/08

(52) U.S. Cl. 428/34.9; 156/218; 225/2; 428/35.7

(57) ABSTRACT

The invention relates to the labeling of industrial cylindrical containers containing acids, alkalis, solvents and other corrosive and non-corrosive chemicals. The label is printed, using a dye sublimation process, onto a plastic sleeve which is placed around the container. A portion of the plastic sleeve is biaxially oriented allowing the label to be affixed to the drum by heat activation. The device may also include a pouch for printed material related to the contents of the container and electronic circuits for tracking the container.

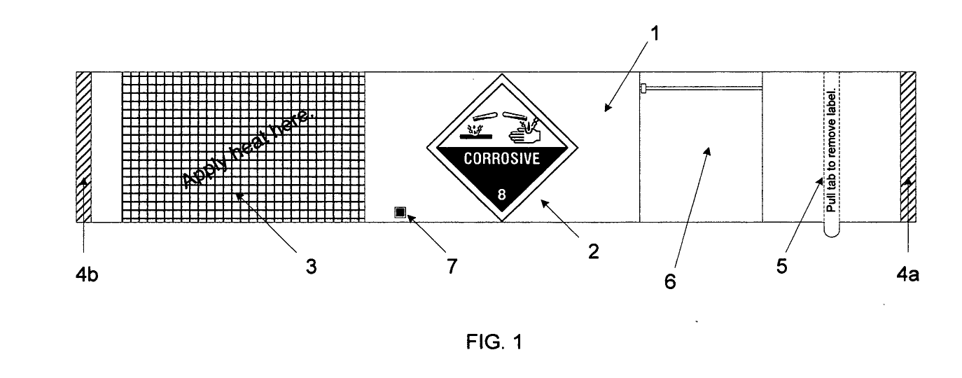

FIG. 1 illustrates the preferred embodiment of the invention. The picture shows the invention after drawing, in other words, in its hybrid state; but before assembly into a sleeve and clamping to an industrial cylindrical container.

### PLASTIC BASE MATERIAL

The invention starts as a chemically resistant polymer (that is to say plastic) sheet or film 1. In the preferred embodiment of the invention the plastic is a polyethylene (PE) sheet 1; although, other chemically resistant thermoplastics are acceptable including, but not limited to, the polyolefin “family” consisting of films made from polyethylene or polyethylene and polypropylene copolymer resins, polyvinyl chloride (PVC)—commonly known as vinyl, chlorinated polyvinyl chloride (CPVC), polyethylene terephthalate (PET), and polyethylene terephthalate glycol (PETG). Prior to drawing the thickness of the plastic sheet is in the range of 4 to 16 mils, although other thicknesses are acceptable.

While many polyethylene films are not desirable for transparent shrink wrap applications within the food industry, due to problems with transparency and permeability to water vapor, these factors are peripheral to PE's selection for labeling industrial cylinders where matching the chemical resistance, the recycling process, and thermal and mechanical properties of the container are critical.

### Dye-Sublimated Printing

In the preferred implementation of the invention images within the area shown 2 would contain both primary and subsidiary labeling and be in compliance with DOT standard 49 CFR 172.407 and other labeling specifications including the OSHA RTK standard—29 CFR, National Fire Protection Agency graphic and hazard ratings diamond—NFPA 704 Hazard Identification System, International Air Transportation Association IATA DGR Section 7 (marking & labeling) and other regulations as understood in the trade. Although, not identified by callout, other printed materials on the plastic film are referred to by the invention under the general heading of the “image” 2.

The current state-of-the-art in chemical resistant signage (CRS) uses off-set printers to apply an image to a paper or vinyl film. The ink which is not resistant to chemicals is then protected by a lacquer or transparent plastic film. If a protective film is used, it may be applied by heat (laminated) or a chemical adhesive. The chemical resistance of the sign is therefore limited by the lacquer, plastic, and bonding adhesive used. In any case, the protective film can be removed by abrasion, thus exposing the underlining ink to a corrosive chemical environment.

Unlike current CRS, in the preferred embodiment of the invention, to create an image 2 on the plastic film 1 an ink composition comprising heat activated ink solids (U.S. Pat. No. 5,488,907) is used. The inks are applied to a medium (typically clay paper) without activating the ink solids during the process of printing. In the final step the image 2 is transferred from the paper to the plastic by applying sufficient heat (typically 350 to 400° F.) and pressure to activate and transfer the ink to the plastic film 1. This process is known in the trade as dye-sublimation printing. Because a solid state mechanism is used to bond the ink within the plastic film, the image 2 assumes the chemical resistance of the plastic film 1. Unlike state-of-the-art CRS, physical abrasion can only result in localized deterioration, and not loss of the image. Dye-sublimation printers which may be used for the application of dye sublimation inks, and whose use is covered under this invention, include, but are not restricted to, ink-jet, off-set, laser, and screen printers. Further, any of the dye-sublimation printers may be used to apply the ink directly to the plastic surface, thus removing the need for a transfer medium. Finally, the glass transition temperature (t_{g}) of the plastic is the critical parameter for transfer of the ink to the plastic film and may be accomplished without the application of pressure.

### Clamping Apparatus

Typically, vinyl CRS signs intended for application to industrial cylindrical containers use an adhesive to bond the sign to the container. This adhesive may degrade over time or when subjected to corrosive chemicals. They further tend to tear or delaminate under rough handling, thermal cycling, and, for plastic drums, changes in the shape of the container due to the loading and unloading of materials. An object of this invention is to use a sleeve which is affixed to the drum by a heat shrinkable strip 3, thus avoiding the use of any adhesives and their attendant problems.

Heat shrinkable films are ubiquitous, typically associated with packaging of foods and medicines; in general, items of irregular shape wherein the wrapper is shrunk to fit snuggly around the item (U.S. Pat. No. 2,762,720). Unfortunately, heat shrinkable films which are activated at temperatures over 212° F. (100° C.) are incompatible with dye sublimation printing, whose inks activate between 350 to 400° F. (177° C. to 204° C.). The preferred embodiment of the invention solves this problem by stretching or rolling or a combination of stretching or rolling a section 3 of the plastic sheet; thus creating a biaxially oriented polymer—known in the trade as drawing. The drawing step is done after the amorphous polymeric sheet has been heated for printing and subsequently supercooled to a temperature below the softening point and suitably in the range from about 212° F. (100° C.) down to room temperature. The percentage of the plastic sheet 1 converted to a biaxially oriented polymer 3, for a plastic industrial drum, is typically from 19% to 30% of the original (pre-shrunk) surface area. However, due to the circumference of the cylindrical container and/or for manufacturing reasons the percentage of biaxially oriented material covered under all embodiments of the invention may be of any percentage. In the event that the printed image 2 is converted to a biaxially oriented polymer 3, the image would be digitally shrunk before printing to compensate for the distortion caused by the drawing of the material. The term “hybrid” will be used synonymously with the amorphous and biaxially oriented nature of the plastic sheet after the drawing process.

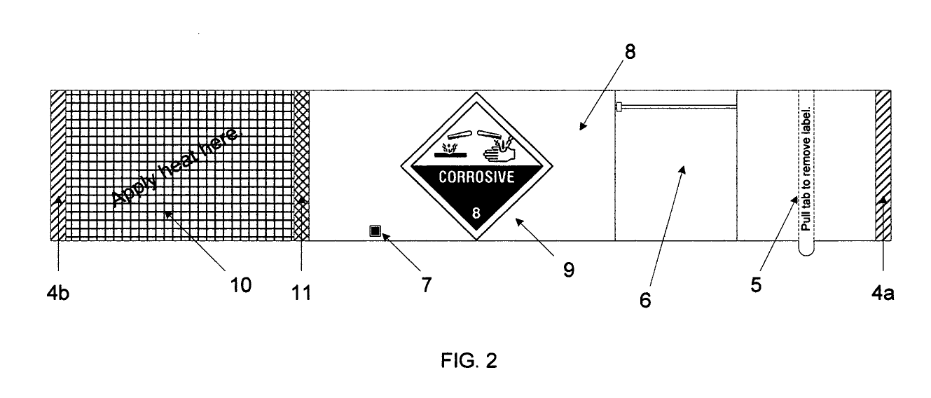

FIG. 2 shows an alternate embodiment of the invention. The image 9 is again printed using dye-sublimation to an amorphous plastic film 8. However, instead of drawing after the dye-sublimation process, a separate heat shrink film 10 is heat welded 11 to the base film 8 after it has cooled. The heat (or energy input) can be generated through a number of methods, such as fusion welding, hot plate, ultrasonic, and vibration. Regardless of how this thermal energy is generated, sufficient thermal energy must be applied to allow the plastic polymer chains to interdiffuse and weld together. In an alternate embodiment of the invention the heat shrink film 10 is attached to the base film 8 using an adhesive.

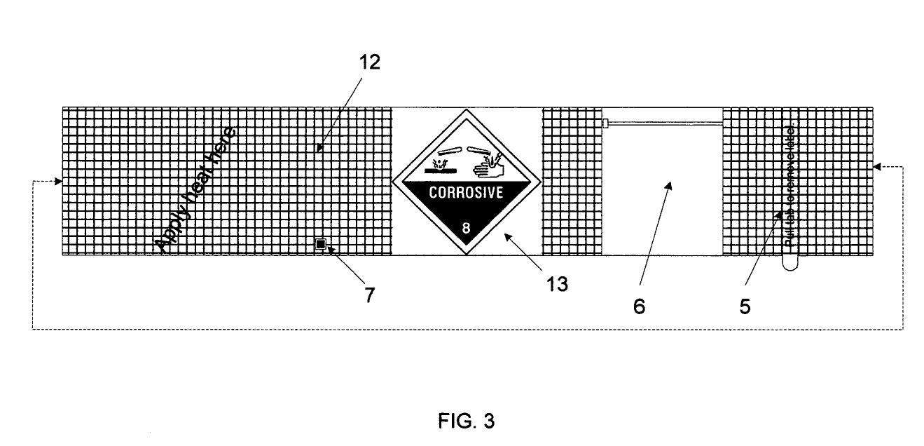

FIG. 3 shows another embodiment of the invention. In this embodiment of the invention the printed base material 13 is heat laminated to the inside of a heat shrink sleeve 12. The form of the embodiment of the invention illustrated in FIG. 3 uses the blown extrusion process, as understood in the trade, to present the heat shrink film as a single sleeve.

All realizations of the invention use heat activation of biaxially oriented polymer to affix, by clamping, the plastic sleeve to an industrial cylindrical container. Heat activation is typically done using a heat gun. For plastic drums, best results are achieved by application of the sleeve when the drum is empty; specifically, when the drum is at its smallest diameter and is most pliable.

### Industrial Cylindrical Containers

The scope of this invention includes all cylindrical containers used in industrial applications; specifically, drums and gas cylinders. An industrial drum is defined as a cylindrical container used for shipping and storing liquid or solid materials. Most HDPE drums are used to ship chemical and petroleum products and are the primary focus of this invention. Drums may be manufactured with steel, plastic (HDPE), or pressed fiberboard (Fiber) and are covered under this invention.

### Sleeve Construction

A plastic film may be manufactured by a blown or cast film extrusion process as understood in the trade. Both extrusion processes may be used to manufacture amorphous or biaxially oriented polymer films. The preferred embodiment of the invention illustrated in FIG. 1, if manufactured using the blown film extrusion process, is extruded as a sleeve thus obviating the need for sealing the two ends 4a, 4b. The alternate embodiment of the invention illustrated in FIG. 3, reflects the manufacture of the invention using the blown film extrusion process. The remainder of this section considers a plastic film manufactured using a cast film extrusion process.

Special coatings are often required to allow heat-shrinkable (biaxially oriented) polymer films to be sealable (U.S. Pat. No. 2,762,720). In the preferred method of the invention illustrated in FIG. 1, a sleeve is formed by heat sealing the two amorphous polymer ends 4a, 4b of the hybrid plastic film; thus obviating the need for the special coatings associated with heat-shrinkable films.

In the alternate embodiment of the invention illustrated in FIG. 2, a sleeve is formed by heat sealing an amorphous polymer film 4b to a commercially available biaxially oriented polymer film 4b. The heat (or energy input) can be generated through a number of methods, such as fusion welding, hot plate, ultrasonic, and vibration. Regardless of how this thermal energy is generated, sufficient thermal energy must be applied to allow the plastic polymer chains to interdiffuse and weld together.

Although not considered advantageous, for either the preferred method of the invention illustrated by FIG. 1 or the alternate embodiment of the invention illustrated in FIG. 2, sealing the two ends 4a, 4b using an adhesive or chemical bonding agent is covered under this invention.

### Label Replacement

When the “real” price of a label is calculated, the most significant elements are life-cycle and replacement costs. Life-cycle costs are a function of physical deterioration of the sign, change in the chemicals stored in the container, and new labeling requirements. Replacement costs include removal of the label and adhesive, and placement of a new label. For traditional signs the removal step, including scraping off the adhesive, can be very time consuming and therefore costly.

All embodiments of the invention allow for, but do not require, a perforated strip 5 (see FIGS. 1, 2, and 3), to be stamped onto the plastic sheet. By removing this strip the label is quickly and easily removed. If a perforated strip is not included as a method of the invention, the label may be removed using a box cutter or other cutting tool.

### Data Sheets

As specified in 49 CFR 172.202 all shipping paper must, as a minimum, include your name and address or that of the recipient, proper shipping name of the hazardous material, hazard class, UN/NA identification number, packing group, total quantity of the shipment (weight or volume), emergency response telephone number, and shipper's certification. It is further specified in 49 CFR 172.406(ii) that the proper shipping name marking be located on the same surface of the package and near the label. Conventional labeling solutions may not meet this requirement.

In the preferred embodiment of the invention, shown in FIG. 1, a pouch is formed by heat welding a second plastic film 6 to an amorphous section of the hybrid plastic base. The pouch can be made re-sealable at the top by any number of ways known in the trade. The pouch is designed to hold the shipping paper required by 49 CFR 172.202 and can in addition be used to hold a Material Safety Data Sheet (MSDS), invoices, and other data associated with the contents of the drum.

All embodiments of the invention allow for, but do not require, a plastic pouch 6 (see FIGS. 1, 2, and 3).

### Radio Frequency Identification and GPS Tracking

The inclusion of a Radio Frequency Identification (RFID) tag, U.S. Pat. No. 3,713,148, and/or GPS tracking device is covered under, but not required by, this invention. The value of RFID and GPS devices are outside the scope of this invention but their vast potential for increasing safety and security within the Chemical and petroleum industry is recognized. A low cost Electronic Product Code (EPC) RFID tag and/or GPS tracking device may be placed in the pouch 6 (see FIGS. 1, 2, and 3) or affixed directly to the plastic sleeve 7 of the invention. Of particular interest to the invention, polymer RFID tags may be heat sealed directly to the label during or after the manufacturing process and in the future printed directly on the polymer sheet itself.

What is claimed is:

1. A device for labeling, tracking, and increasing the safety and security of industrial cylindrical containers within the chemical and petroleum industry, the device comprising: (a) a base material made of an amorphous polymer; (b) printed information applied to the base material using a dye-sublimation process; and (c) a portion of the device where the polymer molecules are biaxially oriented permitting the device, in the form of a sleeve, to be secured to the container without the use of adhesives.

2. A method for manufacturing the device of claim 1 wherein the molecules of the polymer sleeve are both amorphous and biaxially oriented.

3. A method for fabricating the device of claim 1 wherein one end of a printed polymer base material is heat welded to one end of a biaxially aligned polymer film.

4. A method for fabricating the device of claim 1 wherein one end of the printed polymer base material is joined to one end of a biaxially aligned polymer film using an adhesive.

5. A method for fabricating the device of claim 1 wherein the printed surface of the base material is heat laminated to the inside of a biaxially aligned polymer film.

6. The device of claim 1 wherein the sleeve is formed by using a blown extrusion process.

7. The device of claim 1 wherein the sleeve is formed by heat sealing two ends.

8. The device of claim 1 wherein the sleeve is formed by joining two ends by use of an adhesive.

9. The device of claim 1 wherein the sleeve is clamped to an industrial cylindrical container by heat activation of a section of the biaxially oriented polymer portion of the device.

10. The device of claim 1 wherein the plastic is perforated permitting separation of the sleeve from the cylindrical container.

11. A method of removing the device of claim 1 from the container, the method comprising pulling on the device to cause tearing of the plastic, effectuating the removal of the device from the container.

12. The device of claim 1 wherein a portion of the device forms a pouch for holding printed material related to the contents of the industrial container.

13. The device of claim 1 in which an electronic circuit is attached to facilitate tracking of the industrial container and its contents.
